(19) United States
(12) Patent Application Publication
(10) Pub. No.: US 2007/0188605 A1
(43) Pub. Date: Aug. 16, 2007

(54) Irrigation remote sensing system

(75) Inventors: Noel Wayne Anderson, Fargo, ND (US); Mark William Stelford, Sycamore, IL (US); Steven Michael Faivre, Kingston, IL (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/353,351

(22) Filed: Feb. 14, 2006

(51) Int. Cl. H04N 7/18

(52) U.S. Cl. 348/89

(57) ABSTRACT

A data gathering device associated with an agricultural irrigation system including at least one camera movably connected to the irrigation system.

### FIELD OF THE INVENTION

The present invention relates to an agricultural irrigation system, and, more particularly, to a data gathering system associated with the agricultural irrigation system.

### BACKGROUND OF THE INVENTION

Irrigation of agricultural land dates prior to historical records. Some ancient systems simply extended the natural flooding cycles of local rivers, while other systems directed streams into furrows throughout a field to direct moisture to the plants therein. Trickle or drip irrigation is utilized in particularly arid climates to direct small amounts of water to plants to reduce evaporation of the water.

When high pressure delivery systems became available spray irrigation became popular because the water could be projected to great distances by the pressure created by a drive system. The spray irrigation may additionally utilize machinery that relocates the spray nozzles throughout different portions of the field in a controlled manner. A center-pivot system that traverses a field in a circle includes a transportation system that is driven either electrically or by the water pressure itself. The center-pivot system has a series of nozzles along the length of the irrigation system. Typically a center-pivot system has a number of metal frames or transports that hold a water tube above the canopy of the plants with the frames moving in a circular manner about the pivot. The amount of water applied to any particular area of the field is determined by the rate of travel of the system and the amount of water being delivered to the system. It is not unusual for a center-pivot system to be on the order of 1300 feet long and to irrigate a 130 acre circular area.

Irrigation is one of the major uses of water throughout the world. In the United States it is estimated that an average of 137 billion gallons of water were utilized for irrigation on a daily basis in the year 2000. As the number of acres that are irrigated grows so does the use of water. Water is crucial to the growth of plants and the appropriate application of the water is critical for an efficient use of the irrigation system.

Typically, farmers will examine various aspects of the growing crop to determine the effectiveness of the irrigation system and the need for any maintenance of the irrigation system on at least a daily basis. If the farmer has multiple systems in operation a problem with the system or an attack upon the plants by insects, disease, animals or moisture problems may go undetected for a substantial length of time. The delay in detection may lead to further damage to the crop.

What is needed in the art is an information system that can efficiently gather information about the irrigation system and the condition of the agricultural crop.

### SUMMARY OF THE INVENTION

The invention comprises, in one form thereof, a data gathering device associated with an agricultural irrigation system, including at least one camera movably connected to the irrigation system.

The invention comprises, in another form thereof, an irrigation system including at least one transport structure, at least one water delivery tube and a data gathering device. The at least one transport structure is movable in the agricultural field. The at least one water delivery tube is associated with the at least one transport structure and the at least one water delivery tube defines a general direction. The data gathering device is movable in the general direction and the data gathering device includes at least one camera.

### BRIEF DESCRIPTION OF THE DRAWINGS

FIG. 1 illustrates an irrigation system to which is associated an embodiment of a data gathering device of the present invention;

FIG. 2 illustrates another irrigation system with the data gathering device of the present invention and a schematic illustration of a computer in communication with the data gathering device;

FIG. 3 is an illustration of an embodiment of a camera used as a data gathering device of the irrigation systems illustrated in FIGS. 1 and 2; and

FIG. 4 is an illustration of another embodiment of a camera used as a data gathering device of the irrigation systems illustrated in FIGS. 1 and 2.

### DESCRIPTION OF THE PREFERRED EMBODIMENT

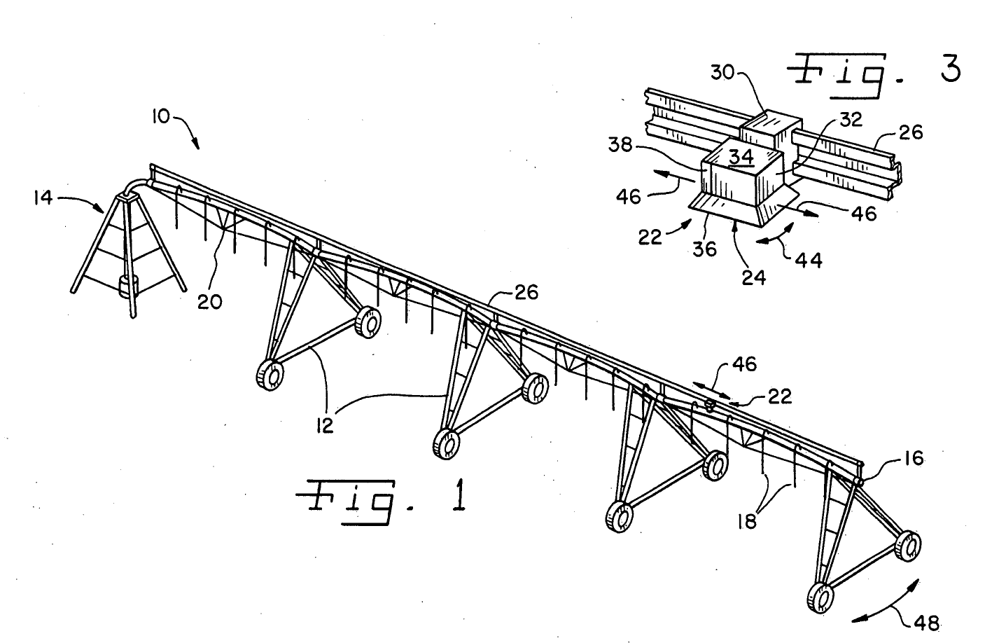

Referring now to the drawings, and more specifically to FIGS. 1 and 2 there are illustrated irrigation systems 10 having transport structures 12 associated therewith. Transport structures 12 may be driven by water pressure or by electric motors associated with each transport structure 12. Even though irrigation system 10 is illustrated and discussed hereafter as a pivot irrigation system, it can be easily understood that the present invention may be applied to any sort of mobile irrigation system. Irrigation system 10 additionally includes a pivot apparatus 14, water delivery pipes 16, nozzles 18, pipe supports 20 and an observation system 22.

Pivot apparatus 14 provides a central point about which irrigation system 10 rotates in a circular manner. Pivot apparatus 14 additionally has a swivelable pipe system for the delivery of water to water delivery pipes 16. Water travels through delivery pipe 16 in a pressurized manner to nozzles 18 for the expulsion of the water therethrough onto the field below. Nozzles 18 may project the water some distance or basically direct it down upon the crop canopy. Pipe support system 20 typically includes rigid structures attached to pipe 16, which are then further supported by cables that traverse the length of each pipe 16 and may be attached to transport structures 12.

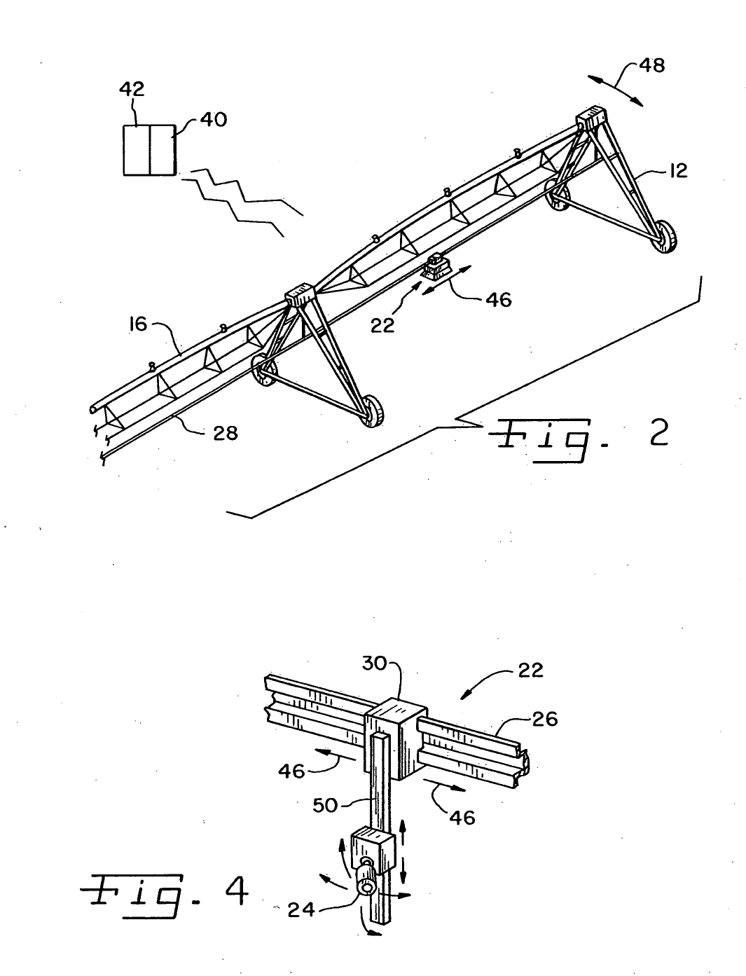

Now, additionally referring to FIG. 3, there are shown additional details of observation system 22. Observation system 22 is movably connected to irrigation system 10 along the length thereof. Observation system 22 may be rigidly supported along pipe 16 or attached to irrigation system 10 in a number of ways. Observation system 22 includes a camera 24 that travels along either a track 26 or a cable 28. Camera 24 includes a conveyance system 30 for conveying camera 24 along either track 26 or cable 28. A power source provides electrical energy to power supply 32 of camera 28 that drives conveyance system 30 and powers electrical circuitry within camera 24. Power supply 32 may include a power storage unit such as batteries and may be periodically recharged along track 26 or cable 28. Track 26 or cable 28 may include power charging stations therealong or may supply constant power to camera 24 along the length thereof. Additionally, a solar panel 34 may be electrically connected to camera 24 to provide at least a portion of the power consumed by camera 24 by way of solar radiation received thereon.

Additionally, associated with camera 24 may be a shield 36 to prevent water from getting upon the optics of camera 24. A communication device 38 transmits data from camera 24 to a data storage device 40 in the form of a computer 40 having its own communication device 42 associated therewith. In the embodiment shown, communication devices 38 and 42 are illustrated as wireless transceivers also known as radio frequency receiver/transmitters.

Now, additionally referring to FIG. 4 there is shown a displacement apparatus 50 connected to a camera 24 and conveyance system 30. Displacement apparatus 50 moves camera 24 in a direction other than direction 46 and displacement apparatus 50 may be a vertical rail or a substantially vertically extending arm that moves camera 24 toward and away from the ground. Displacement apparatus 50 allows camera 24 to be lowered beneath the plant canopy and camera 24 can swivel about in any direction, even around displacement apparatus 50, to gather visual data regarding the condition of the crop. The visual data includes inspection information about the underside of leaves of the crops, as camera 24 can swivel to gather images in a upward vertical direction. Displacement apparatus 50 is under the control of observation system 22 and may include other sensors and actuators. Camera 24 is shown without a shield for the sake of clarity and camera 24 may move with a shield or leave the shield when moving away from conveyance system 30.

Camera 24 may be rotatably movable, as illustrated by arrows 44, from an otherwise fixed position. Water delivery pipes 16 form a basically longitudinal direction 46 which is substantially parallel to track 26 or cable 28 along which camera 24 travels. The traveling of camera 24 along directions 46 while transport sections 12 move in a direction 48, which is substantially perpendicular to directions 46, provide an opportunity for camera 24 to gather data from the crops in the field and irrigation system 10 itself. As camera 24 traverses track 26, or cable 28, data is gathered in the form of visual information, which may be pictures in the visible or invisible spectrums. The data is communicated by way of communication device 38 to communication device 42 and is stored in computer 40. Camera 24 traverses track 26 or cable 28 on a predetermined or programmed manner in order to efficiently record data relative to irrigation system 10 as well as the crops in the field. Computer 40 may analyze the information received from camera 24 and provide conclusions, summaries and/or warnings to an operator relative to conditions in the field or of irrigation system 10. The movement of camera 24 and transport structures 12 allow information from the field to produce stereographic images which will provide information relative to the height of the plant canopy.

Observation system 22 provides valuable information relative to nozzle operation, robotic operations, monitoring of the soil conditions, crop health, staging of the crop, insect identification, disease identification, information relative to scheduled scans of the crop, production of crop images, varied amounts of information specific to directed targets in the field, atmospheric information, infrared canopy scanning, information relative to pollination of the crop, information relative to stomata closure and other items critical to the growing of plants.

Observation system 22 has been described as including camera 24, which can be understood to be a variety of sensors associated with imaging and other non-contact data gathering apparatuses. Multiple cameras 24 may be associated with a single track 26 or cable 28 with cameras 24 gathering information over predetermined lengths of track 26 or cable 28. The data thus gathered is then communicated to computer 40. Computer 40 processes images by way of algorithms contained therein, which may instruct observation system 22 to be at a selected position at a selected time or at a predetermined position of irrigation system 10. Additionally, information processed by computer 40 may be used to communicate instructions to control the speed of transports 12 and the water delivery rate of irrigation system 10.

Having described the preferred embodiment, it will become apparent that various modifications can be made without departing from the scope of the invention as defined in the accompanying claims.

### Assignment

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A data gathering device associated with an agricultural irrigation system, comprising at least one camera movably connected to the irrigation system.

2. The device of claim 1, further comprising one of a track and a cable connected to the irrigation system along which said at least one camera traverses.

3. The device of claim 1, wherein the irrigation system is movable in a first direction and said at least one camera is movable along at least a portion of the irrigation system in a second direction.

4. The device of claim 3, wherein said first direction and said second direction are substantially perpendicular to each other.

5. The device of claim 3, wherein said first direction is arcuate about a pivot point and said second direction is substantially perpendicular to a tangent of said first direction.

6. The device of claim 1, further comprising water delivery pipes that generally define a longitudinal direction, said at least one camera being movable along said longitudinal direction.

7. The device of claim 6, further comprising a displacement apparatus that moves said camera in an other direction than varies from said longitudinal direction.

8. The device of claim 7, wherein said other direction is substantially perpendicular to said longitudinal direction.

9. The device of claim 1, further comprising a wireless communication device communicatively connected to said at least one camera.

10. The device of claim 9, further comprising a data storage device communicatively coupled to said wireless communication device, said data storage device receiving a plurality of images from said at least one camera.

11. The device of claim 10, wherein said data storage device includes computational capability to analyze said plurality of images by way of an algorithm.

12. The device of claim 11, wherein said algorithm provides information from said plurality of images regarding at least one of nozzle operation of the irrigation system, soil conditions, crop health, insect damage to said crop, disease identification, atmospheric information, canopy temperature and effectiveness of chemical applications to said crop.

13. The device of claim 11, wherein said data storage device additionally communications instructions to said at least one camera to direct the position thereof at one of a predetermined time and a predetermined position of the irrigation system.

14. An irrigation system, comprising:
at least one transport structure being movable in an agricultural field;
at least one water delivery tube associated with said at least one transport structure, said at least one water delivery tube defining a general direction; and
a data gathering device movable in said general direction, said data gathering device including at least one camera.

15. The system of claim 14, further comprising one of a track and a cable connected to at least one of said transport structure and said water delivery tube, along which said at least one camera travels.

16. The system of claim 14, wherein said at least one transport structure is movable in a first direction and said at least one camera being movable along at least a portion of the irrigation system in a second direction.

17. The system of claim 16, wherein said first direction and said second direction are substantially perpendicular to each other.

18. The system of claim 16, wherein said first direction is arcuate about a pivot point and said second direction is substantially perpendicular to a tangent of said first direction.

19. The system of claim 14, further comprising a communication device communicatively connected to said at least one camera.

20. The system of claim 19, further comprising a data storage device communicatively coupled to said communication device, said data storage device receiving a plurality of images from said at least one camera.

21. The system of claim 20, wherein said data storage device includes computational capability to analyze said plurality of images by way of an algorithm.

22. The system of claim 21, wherein said algorithm provides information from said plurality of images regarding at least one of nozzle operation of the irrigation system, soil conditions, crop health, insect damage to said crop, disease identification, atmospheric information, canopy temperature and effectiveness of chemical applications to said crop.
